(19) United States
(12) Patent Application Publication
(10) Pub. No.: US 2010/0104322 A1
(43) Pub. Date: Apr. 29, 2010

(54) Image Forming Apparatus

(75) Inventors: Shinichi KAMOSHIDA, Shiojiri-shi (JP); Tadahiro MIZUTANI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/652,618

(22) Filed: Jan. 5, 2010

Related U.S. Application Data
(63) Continuation of application No. 11/781,042, filed on Jul. 20, 2007, now Pat. No. 7,668,483.

(30) Foreign Application Priority Data
Jul. 21, 2006 (JP) 2006-199130

(51) Int. Cl. G03G 15/02

(52) U.S. Cl. 399/176

(57) ABSTRACT

Provided is an image forming apparatus which includes a cylindrical image carrier, on which at least an electrostatic latent image is formed, and a charge roller for non-contact charging the image carrier with a predetermined charge gap, and applies at least an alternating current (AC) voltage to the charge roller to non-contact charge the image carrier, wherein a predetermined number of partition members for partitioning an internal space of the image carrier into a plurality of sub-spaces are arranged at a central position of an axial direction of the image carrier or in the vicinity of the central position of the axial direction of the image carrier, in the image carrier.

### BACKGROUND

1. Technical Field

The present invention relates to an image forming apparatus including an electrophotographic device, such as an electrostatic copier, a printer, a facsimile, or the like, which includes an image carrier, on which at least an electrostatic latent image is formed, and a charge roller for non-contact charging the image carrier by bringing gap members fixed on both ends thereof into contact with the image carrier and setting a predetermined charge gap with respect to the image carrier, and applies at least an alternating current (AC) charge bias to the charge roller.

2. Related Art

In the related art, as an image forming apparatus, an image forming apparatus which forms a predetermined charge gap and has a charge roller for non-contact charging an image carrier to perform a non-contact charging method is disclosed in JP-A-2001-296723. In the charge roller used in the image forming apparatus disclosed in JP-A-2001-296723, a resistance layer formed of a conductive elastic member is provided on the outer circumferential surface of a core, a pair of gap members of formed of an insulating film member having a stripe shape are wound in a ring shape to be adhered, and the pair of gap members are brought into contact with the outer circumferential surface of a photosensitive drum which is the image carrier such that the predetermined charge gap is set between the photosensitive drum and a charge portion of the charge roller between the pair of gap members.

Since the charge portion of the charge roller non-contact charges the photosensitive drum via the charge gap such that ozone can be suppressed from being generated and an extraneous material such as a toner attached to the photosensitive drum can be prevented from being attached to the charge roller or a material included in the resistance layer of the charge roller can be prevented from being attached, the capability of charging the photosensitive drum by the charge roller can be improved.

However, in the above-described non-contact charging method, if the charge gap between the photosensitive layer of the photosensitive body and the charge roller is uneven or a rapid environment variation occurs, charging failure may occur and thus image formation failure may occur. Accordingly, in the related art, this problem was solved by applying a charge bias, which is obtained by superposing a direct current (DC) voltage on an AC voltage, to the charge roller.

However, when the charge bias obtained by superposing the direct current (DC) voltage on the AC voltage is applied to the charge roller, the charge roller may vibrate due to the existence of the AC voltage and thus continuous vibration sound may be generated from the photosensitive body due to the vibration of the charge roller. This is because the charge gap is as small as about 20 μm, air in a minute gap between the photosensitive body and the charge roller exhibits a viscous property with respect to the vibration of the charge roller, and thus the photosensitive body and the charge roller integrally vibrate due to the existence of the viscous property of air.

Accordingly, a technology for suppressing the vibration sound of a photosensitive body by completely or substantially filling an elastic vibration suppression member, such as rubber, in the photosensitive body is suggested in JP-A-2003-302870. In the photosensitive body disclosed in JP-A-2003-302870, since the vibration sound of the photosensitive body is absorbed by the elastic vibration suppression member filled in the photosensitive body, the vibration sound of the photosensitive body is suppressed from being generated although the charge roller vibrates when the AC voltage is applied to the charge roller.

### SUMMARY

However, in the image forming apparatus disclosed in JP-A-2003-302870, since the elastic vibration suppression member is completely or substantially completely embedded in the inner space of the photosensitive body, the elastic vibration suppression member cannot perform a vibration absorption function with certainty when the AC voltage is applied to the charge roller to vibrate the charge roller. Thus, the vibration of the photosensitive body cannot be efficiently and sufficiently suppressed. Accordingly, the distance (charge gap) between the charge roller and the photosensitive body may vary and thus charging failure and banding failure may occur.

An advantage of the invention is to provide an image forming apparatus capable of more efficiently suppressing vibration sound from being generated from an image carrier although at least an AC voltage is applied to a charge roller for charging an image carrier in a non-contact charging method.

According to an aspect of the invention there is provided an image forming apparatus which includes a cylindrical image carrier, on which at least an electrostatic latent, image is formed, and a charge roller for non-contact charging the image carrier with a predetermined charge gap, and applies at least an alternating current (AC) voltage to the charge roller to non-contact charge the image carrier, wherein a predetermined number of partition members for partitioning an internal space of the image carrier into a plurality of sub-spaces are arranged at a central position of an axial direction of the image carrier or in the vicinity of the central position of the axial direction of the image carrier, in the image carrier.

The partition members may be arranged so as to be linearly symmetrical to the central position of the axial direction of the image carrier.

The partition members may be arranged at least at the central position of the axial direction of the image carrier.

The partition members may be formed of an elastic porous member.

The elastic porous member may be a sponge.

According to an image forming apparatus of the invention, since a predetermined number of partition members are provided in an image carrier to partition an internal space of the image carrier into a plurality of sub-spaces, it is possible to more efficiently suppress the large vibration of the image carrier although an AC voltage is applied to a charge roller to vibrate the charge roller.

Accordingly, since the distance between the charge roller and the image carrier is hardly changed and is stably maintained to a predetermined value or less, a charge gap can be stably maintained to be constant. Accordingly, charging failure and banding failure can be prevented and, as a result, a good image can be formed. Vibration sound due to the vibration of the image carrier can be also reduced.

Since an elastic porous member such as a sponge is, for example, used as the partition member, the vibration sound generated at the image carrier is delivered to the partition member via the sub-spaces S₁ and S₂ so as to be efficiently absorbed into a plurality of holes of the partition member. Accordingly, noise generated at the image carrier can be further reduced.

Accordingly, although an AC voltage is applied to the charge roller to charge the image carrier in a non-contact state, the uniform charge gap can be maintained over a longer duration and thus the image carrier can be stably charged. Accordingly, a high-quality image can be obtained over a long duration.

### BRIEF DESCRIPTION OF THE DRAWINGS

The invention will be described with reference to the accompanying drawings, wherein like numbers reference like elements.

FIG. 1 is a schematic partial view showing an example of an image forming apparatus according to an embodiment of the invention.

FIG. 2 is a schematic view showing a photosensitive body and a charge roller shown in FIG. 1, wherein FIG. 2A is a front view thereof and FIG. 2B is a cross-sectional view taken along line IIB-IIB of FIG. 1A.

FIG. 3 is a cross-sectional view similar to FIG. 2B but showing a photosensitive body of another example of the image forming apparatus according to the embodiment of the invention.

FIG. 4 is a cross-sectional view similar to FIG. 2B but showing a photosensitive body of another example of the image forming apparatus according to the embodiment of the invention.

FIG. 5 is a cross-sectional view similar to FIG. 2B but showing a photosensitive body of another example of the image forming apparatus according to the embodiment of the invention.

FIG. 6 is a cross-sectional view similar to FIG. 2B but showing a photosensitive body of a comparative example of the invention.

FIG. 7 is a cross-sectional view similar to FIG. 2B but showing a photosensitive body of another comparative example of the invention.

### DESCRIPTION OF EXEMPLARY EMBODIMENTS

Hereinafter, exemplary embodiments of the invention will be described with reference to the accompanying drawings.

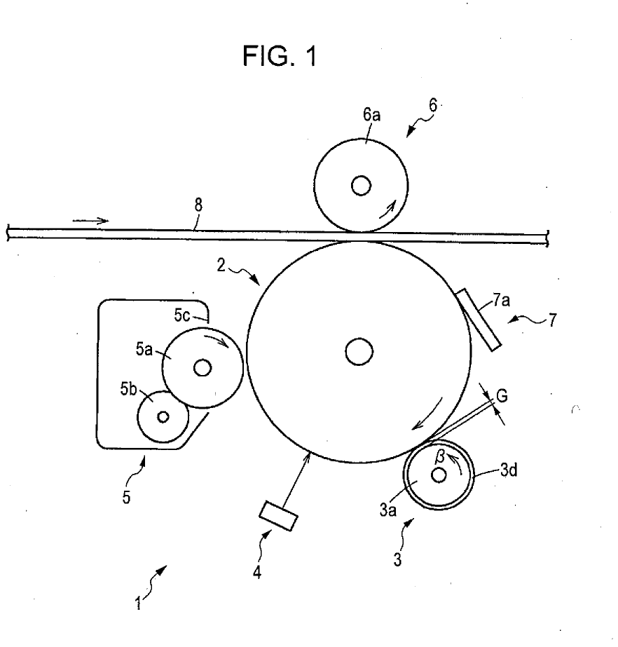

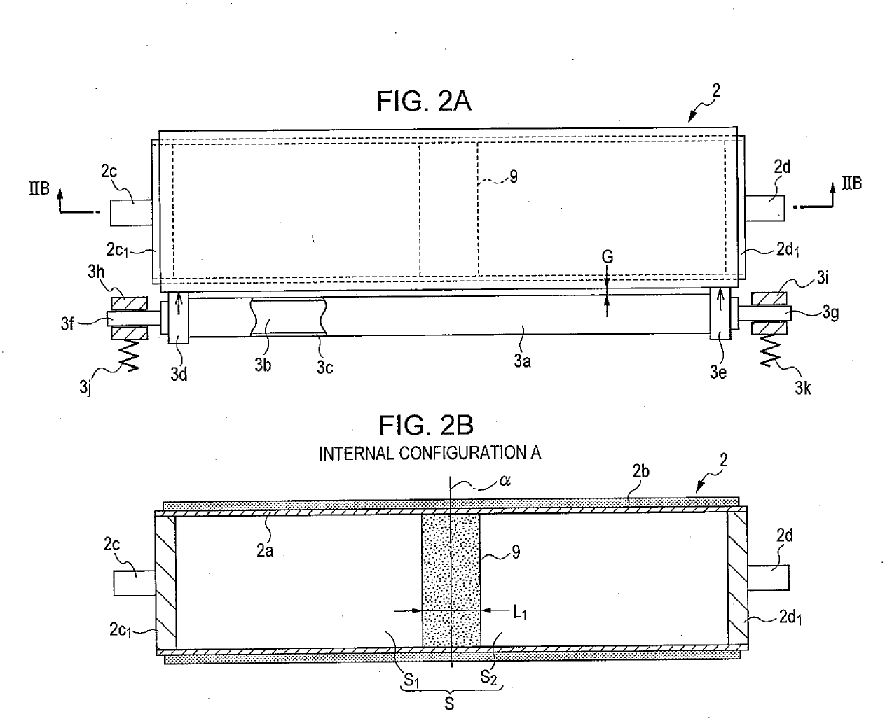

FIG. 1 is a schematic partial view showing an example of an image forming apparatus according to an embodiment of the invention. FIG. 2 is a schematic view showing a photosensitive body and a charge roller shown in FIG. 1, wherein FIG. 2A is a front view thereof and FIG. 2B is a cross-sectional view taken along line IIB-IIB of FIG. 1A.

As shown in FIGS. 1 and 2A, the image forming apparatus 1 includes a photosensitive body 2, which is an image carrier on which an electrostatic latent image and a toner image (developer image) are formed. The photosensitive body 2 rotates in a clockwise direction in FIG. 1. A charge device 3 for non-contact charging the photosensitive body 2, an optical writing device 4 for writing the electrostatic latent image on the photosensitive body 2, a development device 5 for developing the electrostatic latent image of the photosensitive body 2 with a toner, a transfer device for transferring a toner image of the photosensitive body 2, and a cleaning device 7 for cleaning the photosensitive body 2 are sequentially arranged in the vicinity of the photosensitive body 2 from the upstream side of the rotation direction of the photosensitive body 2.

The photosensitive body 2 includes a cylindrical photosensitive drum, in which a photosensitive layer 2b having a predetermined thickness is formed on the outer circumferential surface of a cylindrical base metal pipe 2a, similar to a known photosensitive drum. In the photosensitive body 2, a conductive pipe formed of, for example, aluminum is used in the base metal pipe 2a and a known organic photosensitive material is used in the photosensitive layer 2b. Rotary shafts 2c and 2d coaxially protrude from both ends of the base metal pipe 2a such that flange portions 2c₁ and 2d₁ thereof closely adhere to the inner circumferential surface of the base metal pipe 2a. Accordingly, a sealed space S is formed in the base metal pipe 2a. The photosensitive body 2 is provided such that the rotary shafts 2c and 2d are rotatably supported by a main body (not shown) via bearings.

In this image forming apparatus 1, as shown in FIG. 2B, a partition member 9 which partitions the sealed space S in the base metal pipe 2a into two left and right sealed sub-spaces S₁ and S₂ and has a predetermined width L₁ is provided in the base metal pipe 2a. In this case, the partition member 9 is fixed such that the outer circumferential surface thereof is closely adhered to the inner circumferential surface of the base metal pipe 2a and the center of the predetermined width L₁ of the partition member 9 corresponds to the central position (particularly, the central position between the facing surfaces of the two left and right flange portions 2c₁ and 2d₁) α of the axial direction (horizontal direction in FIG. 2B) of the base metal pipe 2a (that is, linearly symmetrical to a straight line which passes through the central position α of the base metal pipe 2a and is perpendicular to the axial direction).

The partition member 9 is, for example, formed of an elastic porous member such as a sponge. As the elastic sponge, a sponge such as EPT-51 (made by Bridgestone Kaseihin Tokyo Co., Ltd.), Real Sealer (made by Bridgestone Kaseihin Tokyo Co., Ltd.), or QUW (made by Bridgestone Kaseihin Tokyo Co., Ltd.) may be used.

The charge device 3 includes a charge roller 3a for non-contact charging the photosensitive body 2 and the charge roller 3a rotates in a direction β (counterclockwise direction, in FIG. 1) opposite to the rotation direction of the photosensitive body 2. As shown in FIG. 2A, the charge roller has a core 3b and the core 3b is a conductive shaft formed of, for example, a metal. As the conductive shaft, a shaft obtained by plating the surface of SUM22 with Ni may be used.

First and second gap members 3d and 3e are fixed on the outer circumferential surfaces of both ends of the core 3b by winding a film member formed of, for example, an adhesive tape having a predetermined thickness with a predetermined width in a ring shape. The outer circumferential surface of the core 3b between the first and second gap members 3d and 3e is coated with a conductive coating material by a spray coating method to form a resistance layer 3c. The resistance layer may be formed on the entire surface of the outer circumferential surface of the core 3b by the same method and then the same first and second gap members 3d and 3e may be provided on the outer circumferential surfaces of both ends of the resistance layer 3c.

The charge roller 3a has rotary shafts 3f and 3g coaxially protruding from both end surfaces of the core 3b and the rotary shafts 3f and 3g are rotatably supported by bearings 3h and 3i. Similar to the related art, the charge roller 3a is pressed toward the photosensitive body 2 by the loads of compression springs 3j and 3k via the bearings 3h and 3i of the rotary shafts 3f and 3g of the charge roller 3a such that the first and second gap members 3d and 3e are pressed against the outer circumferential surface of the photosensitive body 2. Accordingly, a predetermined gap G between the resistance layer 3c and the photosensitive body 2 based on the predetermined thickness of the film member is set. In the charge device 3, the photosensitive body 2 is uniformly charged by the charge roller 3a in a non-contact state with the charge gap G.

The optical writing device 4 writes an electrostatic latent image on the photosensitive body 2, for example, using laser light. The development device 5 includes a development roller 5a, a toner supplying roller 5b, and a toner layer thickness regulating member 5c. A toner which is a development agent (not shown) is supplied onto the development roller 5a by the toner supplying roller 5b, the toner on the development roller 5a is carried to the photosensitive body 2 after the thickness thereof is regulated by the toner layer thickness regulating member 5c, and the electrostatic latent image on the photosensitive body 2 is developed with the carried toner, thereby forming a toner image on the photosensitive body 2.

The transfer device 6 has a transfer roller 6a. The toner image on the photosensitive body 2 is transferred onto a transfer medium 8 such as a transfer sheet or an intermediate transfer medium by the transfer roller 6a. When the toner image is transferred onto the transfer sheet which is the transfer medium 8, the toner image on the transfer sheet is fixed by the fixing device (not shown) and an image is formed on the transfer sheet. When the toner image is transferred onto the intermediate transfer medium which is the transfer medium 8, the toner image on the intermediate transfer medium is transferred onto a transfer sheet and the toner image on the transfer sheet is fixed by the fixing device (not shown), thereby forming an image on the transfer sheet.

The cleaning device 7 has a cleaning member 7a such as a cleaning blade. The photosensitive body 2 is cleaned by the cleaning member 7a and the toner left on the photosensitive body 2 after transfer is removed and collected.

In this image forming apparatus 1, since the partition member 9 is provided at the axial central position of the base metal pipe 2a of the photosensitive body 2 to partition the space S in the base metal pipe 2a into the two sub-spaces S₁ and S₂, it is possible to more efficiently suppress the large vibration of the photosensitive body 2 although an AC voltage is applied to the charge roller 3a to vibrate the charge roller 3a. Accordingly, since the distance between the charge roller 3a and the photosensitive body 2 is negligibly changed and is stably maintained to a predetermined value or less, the charge gap G can be stably maintained to be constant. Accordingly, charging failure and banding failure can be prevented and, as a result, a good image can be formed. Vibration sound due to the vibration of the photosensitive body 3 can be also reduced.

Since the elastic porous member such as the sponge is, for example, used as the partition member 9, the vibration sound generated at the photosensitive body 2 is delivered to the partition member via the spaces S₁ and S₂ so as to be efficiently absorbed into a plurality of holes of the partition member 9. Accordingly, noise generated at the photosensitive body 2 can be further reduced.

Accordingly, although a bias obtained by superposing a DC voltage on an AC voltage is applied to the charge roller 3a to charge the photosensitive body 2 in a non-contact state, the uniform charge gap G can be maintained over a longer duration and thus the photosensitive body 2 can be stably charged. Accordingly, a high-quality image can be obtained over a long duration.

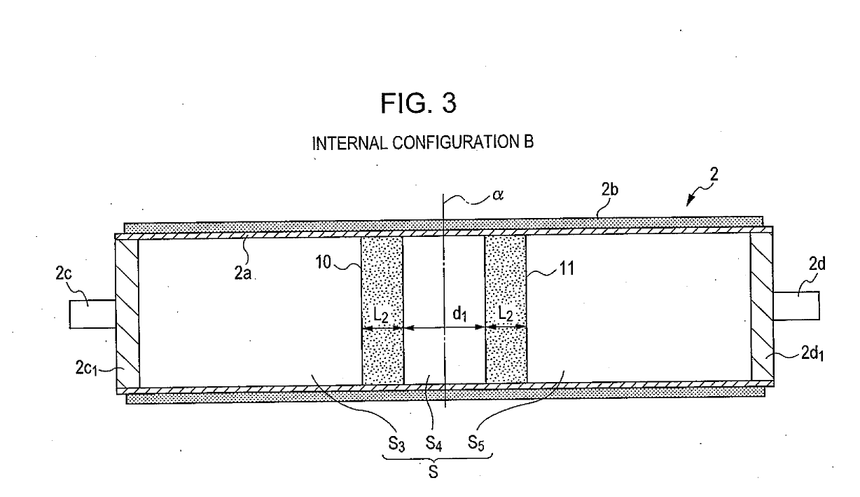

FIG. 3 is a cross-sectional view similar to FIG. 2B but showing a photosensitive body of another example of the image forming apparatus according to the embodiment of the invention.

Although, in the example shown in FIG. 2B, one partition member 9 having the width L₁ is provided in the base metal pipe 2a of the photosensitive body 2 to partition the sealed space S in the base metal pipe 2a into the two sub-spaces S₁ and S₂, in the photosensitive body 2 of the image forming apparatus shown in FIG. 3, two partition members 10 and 11 each having a predetermined width L₂ are provided in the base metal pipe 2a to partition the sealed space S in the base metal pipe 2a into three sub-spaces S₃, S₄ and S₅. In this case, the two partition members 10 and 11 are not provided at the central position α and are positioned in the vicinity of the central position α at a predetermined distance d₁ so as to be linearly symmetrical to a straight line which passes through the central position α and is perpendicular to the axial direction. The two partition members 10 and 11 are formed of the same elastic porous member as the partition member 9 of the above-described example.

The other configuration of the photosensitive body 2 and the other configuration of the image forming apparatus 1 of this example are respectively the same as those of the photosensitive body 2 and the image forming apparatus 1 shown in FIGS. 1, 2A and 2B, and the operation and the effect of the photosensitive body 2 and the image forming apparatus 1 of this example are substantially the same as those of the photosensitive body 2 and the image forming apparatus 1 of the above-described example. The widths L₂ of the two partition members 10 and 11 may be different from each other. In this case, the two partition members 10 and 11 are not linearly symmetrical to the straight line passing through the central position α.

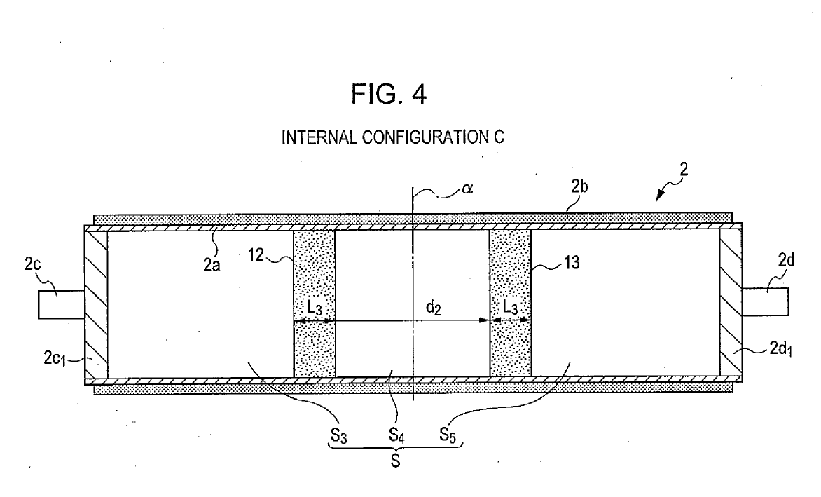

FIG. 4 is a cross-sectional view similar to FIG. 2B but showing a photosensitive body of another example of the image forming apparatus according to the embodiment of the invention.

Although, in the example shown in FIG. 3, the two partition members 10 and 11 each having the predetermined width L₂ are provided in the base metal pipe 2a at the predetermined distance d₁ so as to be linearly symmetrical to the straight line passing through the central position α, in the photosensitive body 2 of the image forming apparatus 1 shown in FIG. 4, two partition members 12 and 13 each having a predetermined width L₃ are provided in the base metal pipe 2a at a predetermined distance d₂ larger than the distance d₁ so as to be linearly symmetrical to the central position α. The two partition members 12 and 13 are formed of the same elastic porous member as the partition member 9 of the above-described example. Since the photosensitive body 2 is schematically shown in FIG. 4, the two partition members 12 and 13 are shown to be farther away from the flange portions 2c₁ and 2d₁ than the central position α. However, actually, half the axial distance d₂ of the sub-space S4 is set to be significantly smaller than the axial distance of the left and right sub-spaces S₃ and S₅. That is, the two partition members 12 and 13 are arranged closer to the central position α than the flange portions 2c₁ and 2d₁ and, in this case, the two partition members 12 and 13 are arranged in the vicinity of the central position α.

The other configuration of the photosensitive body 2 and the other configuration of the image forming apparatus 1 of this example are equal to those of the above-described example, and the operation and the effect of the photosensitive body 2 and the image forming apparatus 1 of this example are substantially equal to those of the above-described example. The widths L₃ of the two partition members 12 and 13 may be different from each other. In this case, the two partition members 12 and 13 are not linearly symmetrical to the straight line passing through the central position α.

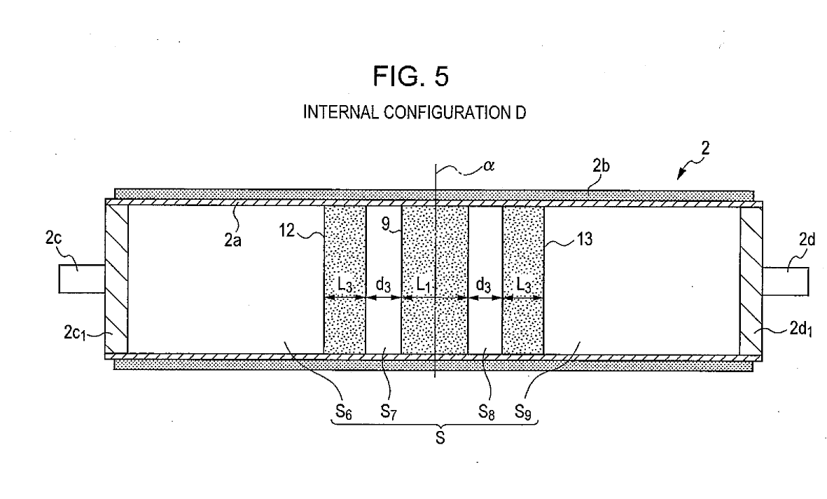

FIG. 5 is a cross-sectional view similar to FIG. 2B but showing a photosensitive body of another example of the image forming apparatus according to the embodiment of the invention.

As shown in FIG. 5, in the photosensitive body 2 of the image forming apparatus 1 of this example, a combination of one partition member 9 of the photosensitive body 2 shown in FIGS. 2A and 2B and the two partition members 12 and 13 of the photosensitive body 2 shown in FIG. 4 is formed. In this case, the partition member 9 is provided similar to the example shown in FIGS. 2A and 2B and the two partition members 12 and 13 are provided similar to the example shown in FIG. 4. Accordingly, one partition member 9 is arranged between the two partition members 12 and 13 to form a predetermined distance d₃ therebetween. The sealed space S in the base metal pipe 2a is partitioned into four sub-spaces S₆, S₇, S₈ and S₉ by the three partition members 9, 12 and 13.

The other configuration of the photosensitive body 2 and the other configuration of the image forming apparatus 1 of this example are equal to those of the above-described example, and the operation and the effect of the photosensitive body 2 and the image forming apparatus 1 of this example are substantially equal to those of the above-described examples. The widths L₃ of the two partition members 12 and 13 may be different from each other. In this case, the two partition members 12 and 13 are not linearly symmetrical to the straight line passing through the central position α.

Although the partition members 9, 10, 11, 12 and 13 are provided so as to be linearly symmetrical to the central position α in the above-described examples, the invention is not limited to the examples and the partition members 9, 10, 11, 12 and 13 may not necessarily provided so as to be linearly symmetrically to the central position α. However, in order to suppress a variation in distance between the photosensitive body 2 and the charge roller 3a as small as possible and equalize the distance between the photosensitive body 2 and the charge roller 3a in the axial direction as much as possible, it is preferable that the partition members 9, 10, 11, 12 and 13 are provided so as to be linearly symmetrical to the central position α.

Next, an experiment for confirming the effect which can be obtained by the invention was performed.

### Experimental Apparatus

As an experimental apparatus, a device obtained by reconstructing a color printer LP9000C which is made by Seiko Epson Corporation and is available commercially was used. The outline of the experimental apparatus is shown in Table 1.

TABLE 1

| Element | Details |
|---|---|
| Photosensitive | Photosensitive drum of LP9000C (made by SEIKO |
| body | EPSON CORPORATION) |
| Charge roller | Non-contact AC Charge roller |
| | Metal roller having a diameter φ + |
| | Resistance layer (surface layer) having a |
| | thickness 30 μm of Table 2 |
| | Standard specifications of the material of |
| | resistance layer: polyurethane resin of 30 wt |
| | %, acrylic resin of 30 wt %, and conductive |
| | tin oxide of 40 wt % |
| | The amount of the conductive tin oxide was |
| | adjusted to become ±10 wt % from the standard |
| | specifications and a variation in amount of |
| | conductive tin oxide was adjusted by varying |
| | the amount of polyurethane resin. |
| | Gap member: polyester table having a |
| | thickness 22 μm |
| | Charge region width: 330 mm |
| | Gap width (one side): 5 mm |
| | Contact pressure: 500 gf/cm |
| Cleaning blade | Cleaning blade of LP9000C (made by SEIKO |
| | EPSON CORPORATION) |
| Optical | Exposure unit of LP9000C (made by SEIKO |
| writing device | EPSON CORPORATION) |
| Development | Development device of LP9000C (made by SEIKO |
| device | EPSON CORPORATION) (including a genuine |
| | toner) |
| Transfer | Transfer device of LP9000C (made by SEIKO |
| device | EPSON CORPORATION) (including a transfer |
| | belt) |
| Fixing device | Fixing device of LP9000C (made by SEIKO |
| | EPSON CORPORATION) |
| AC power | TreK (for AC output) (made by TREK, INC. of |
| source | United States) |

As shown in Table 1, in an image forming apparatus which is the experimental apparatus, a photosensitive drum, a cleaning blade, an optical writing device, a development device (including a genuine toner), a transfer device (including an intermediate transfer belt), and a fixing device of the color printer LP9000C made by Seiko Epson Corporation were used as a photosensitive body, a cleaning blade, an optical writing device which is an exposure device, a development device, a transfer device, and a fixing device, respectively.

A photosensitive body 2 having a sponge filling and a photosensitive body having no a sponge filling were manufactured, several charge rollers (CR) 3a were manufactured, and Experiments 1 to 16 were performed by various combinations of the photosensitive bodies 2 and the charge rollers 3a.

The photosensitive body 2 having the sponge was configured by providing a sponge in the base metal pipe 2a of the photosensitive drum of the printer LP9000C. The distance between the facing surfaces of a pair of left and right flange portions 2c₁ and 2d₁ of the photosensitive body 2 (effective length of the axial direction of the base metal pipe 2a) is 318 mm. As the sponge, EPT-51 purchased from Bridgestone Kaseihin Tokyo Co., Ltd was used. The internal configurations of the photosensitive drums used in the experiments are shown in Table 2.

TABLE 2

| | | | | | | | Photosensitive | | result | |
|---|---|---|---|---|---|---|---|---|---|---|
| | CR | | | | | | body | | Acoustic | |
| | | | | V_{DC} | | | Internal | Type of | pressure | |
| No. | φ (mm) | G (μm) | R (Ω) | (−V) | V_{PP} (V) | f (Hz) | configuration | filling | (dB) | |
| 1 | 9 | 20 | 1.2 × 10⁶ | 600 | 1600 | 1.3 | A | Sponge | 42 | ◯ |
| 2 | 10 | 21 | 5.2 × 10⁶ | 580 | 1650 | 1.2 | B | Sponge | 43 | ◯ |
| 3 | 11 | 18 | 5.2 × 10⁷ | 590 | 1700 | 1.5 | C | Sponge | 45 | ◯ |
| 4 | 12 | 34 | 5.2 × 10⁵ | 550 | 1800 | 1.4 | D | Sponge | 44 | ◯ |
| 5 | 9 | 28 | 1.2 × 10⁷ | 600 | 1690 | 1.6 | A | Sponge | 45 | ◯ |
| 6 | 10 | 26 | 8.2 × 10⁶ | 580 | 1800 | 1.2 | B | Sponge | 44 | ◯ |
| 7 | 11 | 27 | 3.2 × 10⁷ | 590 | 1900 | 1.3 | C | Sponge | 46 | ◯ |
| 8 | 12 | 45 | 6.2 × 10⁶ | 550 | 1890 | 1.5 | D | Sponge | 46 | ◯ |
| 9 | 9 | 20 | 1.2 × 10⁶ | 600 | 1600 | 1.3 | E | Sponge | 53 | X |
| 10 | 10 | 21 | 5.2 × 10⁶ | 580 | 1650 | 1.2 | F | None | 55 | X |
| 11 | 11 | 18 | 5.2 × 10⁷ | 590 | 1700 | 1.5 | E | Sponge | 56 | X |
| 12 | 12 | 34 | 5.2 × 10⁵ | 550 | 1800 | 1.4 | F | None | 54 | X |
| 13 | 9 | 28 | 1.2 × 10⁷ | 600 | 1690 | 1.6 | E | Sponge | 57 | X |
| 14 | 10 | 26 | 8.2 × 10⁶ | 580 | 1800 | 1.2 | F | None | 58 | X |
| 15 | 11 | 27 | 3.2 × 10⁷ | 590 | 1900 | 1.3 | E | Sponge | 56 | X |
| 16 | 12 | 45 | 6.2 × 10⁶ | 550 | 1890 | 1.5 | F | None | 59 | X |

The charge roller 3a is a non-contact charge roller, the metal core 3b was formed by plating the surface SUM22 with Ni, and the surface layer formed of the resistance layer having a thickness 30 μm was formed on the core 3b having a diameter φ shown in Table 2. The standard specifications of the material of the resistance layer 3c include polyurethane resin of 30 wt %, acrylic resin of 30 wt %, and conductive tin oxide of 40 wt %. In this case, the amount of the conductive tin oxide was adjusted to become ±10 wt % from the standard specifications and a variation in amount of conductive tin oxide was adjusted by varying the amount of polyurethane resin. The gap members 3d and 3e for forming the charge gap G on the surface layer of the both ends were configured by winding a polyester tape having a thickness of 22 μm on the resistance layer 3c. In this case, the charge roller 3a used in the present experiment was completed by doubly winding the polyester tape at predetermined positions of the both ends of the core 3b and coating the outer circumferential surface of the core 3a with a material obtained by dissolving the above-described material in water and ethanol to form the resistance layer 3c.

As an AC power supply, Trek (for AC output) (made by TREK, INC. of United States) was used. As a DC power supply, one's own work was used.

In addition, the image forming apparatus shown in FIG. 1 was manufactured using the above-described components.

### Experimental Conditions and Results

In Experiments 1 to 16, printing tests were performed under the experimental conditions shown in Table 2. Experiments 1 to 16 have common experimental conditions that the charge voltage applied to the charge roller 3a was a voltage obtained by superposing a DC voltage V_{DC} on an AC voltage V_{PP} and the AC voltage V_{PP} was a sine wave. In addition, the process velocity was 210 mm/sec and the ratio of the circumferential velocity of the charge roller to the circumferential velocity of the photosensitive body was 1. The experimentally obtained applied voltage was a voltage obtained by superposing the DC voltage on the AC voltage and was a rectangular wave (duty cycle of 50% wherein the DC voltage V_{DC} was −200 V, the AC voltage V_{PP} was 1400 V, the frequency f of the AC voltage was 3.0 kHz, and the transfer applied voltage was +200 V.

The experimental conditions of each of Experiments 1 to 16 will be described.

As shown in Table 2, the experimental conditions of Experiment 1 were as follows: the diameter φ of the metal shaft of the charge roller (CR) was 9 mm, the gap G was 20 μm, the resistance R of the resistance layer was 1.2×10⁶Ω, the DC voltage V_{DC} of the charge voltage was −600 V, the AC voltage V_{PP} of the charge voltage was 1600 V, the frequency f of the AC voltage V_{PP} was 1.3 Hz, the internal configuration of the photosensitive body was the configuration shown in FIGS. 2A and 2E (denoted by A in Table 2), and the partition member of the sponge was included. The width L₁ of the partition member 9 was 20 mm.

In the experimental conditions of Experiment 2 were as follows: the diameter φ was 10 mm, the gap G was 21 μm, the resistance R was 5.2×10⁶Ω, the DC voltage V_{DC} was −600 V, the AC voltage V_{PP} was 1650 V, the frequency f was 1.2 Hz, the internal configuration was the configuration shown in FIG. 3 (denoted by E in Table 2), and the sponge was included. The widths L₂ of the partition members 10 and 11 were 10 mm and the distance d₁ between the partition members 10 and 11 was 20 mm.

The experimental conditions of Experiment 3 were as follows: the diameter φ was 11 mm, the gap G was 18 μm, the resistance R was 5.2×10⁷Ω, the DC voltage V_{DC} was −590 V, the AC voltage V_{PP} was 1700 V, the frequency f was 1.5 Hz, the internal configuration was the configuration shown in FIG. 4 (denoted by C in Table 2), and the sponge was included. The widths L₃ of the partition members 12 and 13 were 10 mm and the distance d₂ between the partition members 12 and 13 was 40 mm.

The experimental conditions of Experiment 4 were as follows: the diameter φ was 12 mm, the gap G was 34 μm, the resistance R was 5.2×10⁵Ω, the DC voltage V_{DC} was −550 V, the AC voltage V_{PP} was 1800 V, the frequency f was 1.4 Hz, the internal configuration was the configuration shown in FIG. 5 (denoted by D in Table 2), and the sponge was included. The width L₁ of the partition member 9 was 20 mm, the widths L₃ of the partition members 12 and 13 were 10 mm, and the distance d₃ between the partition members 9 and 12 and the distance d₃ between the partition members 9 and 13 were 10 mm.

The experimental conditions of Experiment 5 were as follows: the diameter φ was 9 mm, the gap G was 28 μm, the resistance R was 1.2×10⁷Ω, the DC voltage V_{DC} was −600 V, the AC voltage V_{PP} was 1690 V, the frequency f was 1.6 Hz, the internal configuration was the same configuration A as that in Experiment 1, and the sponge was included.

The experimental conditions of Experiment 6 were as follows: the diameter φ was 10 mm, the gap G was 26 μm, the resistance R was 8.2×10⁶Ω, the DC voltage V_{DC} was −580 V, the AC voltage V_{PP} was 1800 V, the frequency f was 1.2 Hz, the internal configuration was the same configuration B as that in Experiment 2, and the sponge was included.

The experimental conditions of Experiment 7 were as follows: the diameter φ was 11 mm, the gap G was 27 μm, the resistance R was 3.2×10⁷Ω, the DC voltage V_{DC} was −590 V, the AC voltage V_{PP} was 1900 V, the frequency f was 1.3 Hz, the internal configuration was the same configuration C as that in Experiment 3, and the sponge was included.

The experimental conditions of Experiment 8 were follows, the diameter φ was 12 mm, the gap G was 45 μm the resistance R was 6.2×10⁶Ω, the DC voltage V_{DC} was −550 V, the AC voltage V_{PP} was 1890 V, the frequency f was 1.5 Hz, the internal configuration was the same configuration D as Experiment 4, and the sponge was included.

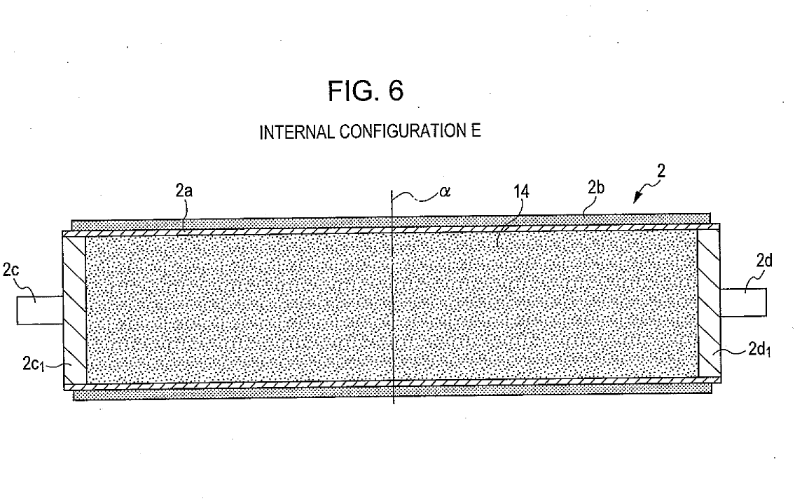

The experimental conditions of Experiment 9 were as follows, the diameter φ was 9 mm, the gap G was 20 μm, the resistance R was 1.2×10⁶Ω, the DC voltage V_{DC} was −600 V, the AC voltage V_{PP} was 1600 V, the frequency f was 1.3 Hz, the internal configuration was the configuration shown in FIG. 6 (denoted by E in Table 2), and the sponge was included. As shown in FIG. 6, in the photosensitive body 2 used in this experiment, the sponge 14 is completely or substantially completely filled in the base metal tube 2a, and the sealed space S in the base metal pipe 2a is not partitioned into a plurality of sub-spaces. That is, the sponge does not configure the partition member.

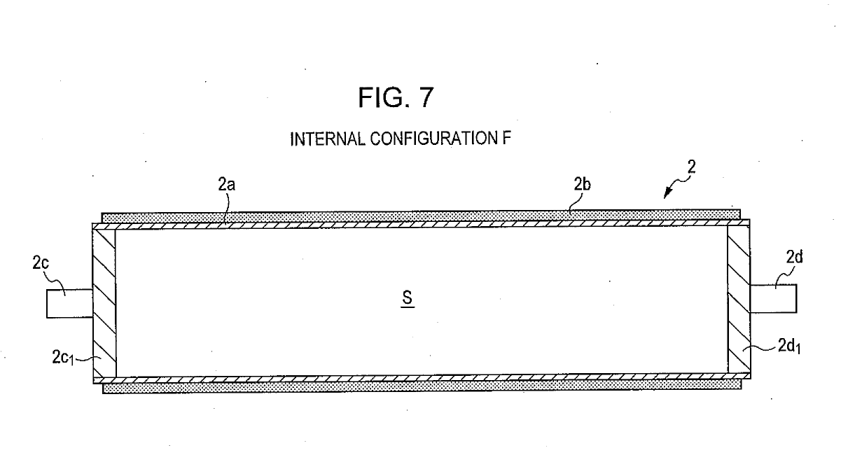

The experimental conditions of Experiment 10 were as follows: the diameter φ was 10 mm, the gap G was 21 μm, the resistance R was 5.2×10⁶Ω, the DC voltage V_{DC} was −580 V, the AC voltage V_{PP} was 1650 V, the frequency f was 1.2 Hz, the internal configuration was the configuration shown in FIG. 7 (denoted by F in Table 2), and the sponge was not included. As shown in FIG. 7, in the photosensitive body 2 used in this experiment, the sponge is not disposed inside the base metal tube 2a, and the sealed space S in the base metal pipe 2a is not partitioned into a plurality of sub-spaces.

The experimental conditions of Experiment 11 were as follows: the diameter φ was 11 mm, the gap G was 18 μm, the resistance R was 5.2×10⁷Ω, the DC voltage V_{DC} was −590 V, the AC voltage V_{PP} was 1700 V, the frequency f was 1.5 Hz, the internal configuration was the same configuration E as that in Experiment 9, and the sponge was included.

The experimental conditions of Experiment 12 were as follows: the diameter φ was 12 mm, the gap G was 34 μm, the resistance R was 5.2×10⁵Ω, the DC voltage V_{DC} was −550 V, the AC voltage V_{PP} was 1800 V, the frequency f was 1.4 Hz, the internal configuration was the same configuration F as that in Experiment 10, and the sponge was not included.

The experimental conditions of Experiment 13 were as follows, the diameter φ was 9 mm, the gap G was 28 μm, the resistance R was 1.2×10⁷Ω, the DC voltage V_{DC} was −600 V, the AC voltage V_{PP} was 1690 V, the frequency f was 1.6 Hz, the internal configuration was the same configuration E as that in Experiment 9, and the sponge was included.

The experimental conditions of Experiment 14 were as follows: the diameter φ was 10 mm, the gap G was 26 μm, the resistance R was 8.2×10⁶Ω, the DC voltage V_{DC} was −580 V, the AC voltage V_{PP} was 1800 V, the frequency f was 1.2 Hz, the internal configuration was the same configuration F as that in Experiment 10, and the sponge was not included.

The experimental conditions of Experiment 15 were as follows: the diameter φ was 11 mm, the gap G was 27 μm, the resistance R was 3.2×10⁷Ω, the DC voltage V_{DC} was −590 V, the AC voltage V_{PP} was 1900 V, the frequency f was 1.3 Hz, the internal configuration was the same configuration E as that in Experiment 9, and the sponge was included.

The experimental conditions of Experiment 16 were as follows: the diameter φ was 12 mm, the gap G was 45 μm, the resistance R was 6.2×10⁶Ω, the DC voltage V_{DC} was −550 V, the AC voltage V_{PP} was 1890 V, the frequency f was 1.5 Hz, the internal configuration was the same configuration F as that in Experiment 10, and the sponge was not included.

Accordingly, Experiments 1 to 8 are embodiments of the invention and Experiments 9 to 16 are comparative examples of the invention.

### Noise Measurement Test

A noise measurement test is the same in Experiments 1 to 16 and monochromic printing of 5% was sequentially performed with respect to 100 sheets of plain paper having A4 size, and an acoustic pressure (dB) for 10 seconds was measured using a normal sound level meter LA-1210 (made by ONO SOKKI CO., LTD.) between 20^{th} to 80^{th} sheets. The environment for measuring noise at this time is a normal environment (a temperature 23° C. and a humidity is 65% R.H.).

### Result

The experimental result is shown in Table 2. In this case, an FFT analysis was performed with respect to the measured acoustic pressure (dB), a frequency component (one-time vibration (3.0 kHz) to 6-time vibration (18.0 kHz) of a development frequency of 3.0 kHz was deleted, and comparison and evaluation were performed as the whole acoustic pressure, thereby obtaining the acoustic pressure (dB). If the obtained acoustic pressure (dB) is equal to or greater than 50 (dB), it was determined to be bad (x) and, if the obtained acoustic pressure (dB) is less than 50 (dB), it was determined to be good (O).

As can be seen from Table 2, in the Experiments 1 to 8 of the embodiments of the invention, since the acoustic pressure (dB) is less than 50 dB and is relatively small, the photosensitive body 2 does not vibrate although the AC voltage is applied to the charge roller 3a and thus a good result is obtained. In the Experiments 9 to 16 of the comparative examples of the invention, since the acoustic pressure (dB) is equal to or greater than 50 dB, the photosensitive body 2 greatly vibrates and thus a bad result is obtained. Accordingly, it was confirmed that the effect can be obtained by the invention.

An image forming apparatus of the invention is applicable to an image forming apparatus including electrophotographic device which includes an image carrier, on which at least an electrostatic latent image is formed, and a charge roller for non-contact charging the image carrier by bringing gap members fixed on the both ends thereof into contact with the image carrier and setting a predetermined charge gap with respect to the image carrier, and applies at least an alternating current (AC) charge bias to the charge roller, such as an electrostatic copier, a printer, a facsimile, or the like.

1-5. (canceled)

6. An image forming apparatus comprising:
a cylindrical image carrier on which an electrostatic latent image is to be formed;
a charger applied with an alternating current (AC) voltage to non-contact charge the image carrier across a charge gap; and
an elastic member arranged at an internal space of the image carrier.

7. The image forming apparatus according to claim 6, wherein the charger is a charging roller.

8. The image forming apparatus according the claim 7, wherein the charging roller charges the image carrier with a predetermined charge gap.

9. The image forming apparatus according to claim 8, further comprising a gap member that maintains the charge gap between the charger and the image carrier, wherein the elastic member is located within an internal space of the image carrier and outside region of the image carrier corresponding to the gap member.
